(19) United States
(12) Patent Application Publication
(10) Pub. No.: US 2014/0302224 A1
(43) Pub. Date: Oct. 9, 2014

(54) PROTEIN SEASONINGS AND METHODS OF MAKING THE SAME

(71) Applicant: PROCESS Foods, LLC, Malvern, PA (US)

(72) Inventors: Nicholas C. Bardoutsos, Philadelphia, PA (US); Randy Nichol, Malvern, PA (US)

(21) Appl. No.: 14/354,013

(22) PCT Filed: Oct. 24, 2012
(86) PCT No.: PCT/US12/61600

§ 371 Date: Apr. 24, 2014

Related U.S. Application Data
(60) Provisional application No. 61/550,824, filed on Oct. 24, 2011.

(51) Int. Cl. A23J 3/08; A23L 1/22

(52) U.S. Cl. CPC A23J 3/08; A23L 1/22
USPC 426/650

(57) ABSTRACT

A protein seasoning and methods of making the same are provided. A formulation can be provided comprising a base combined with a protein source, which can be combined with various flavored seasonings/ingredients to form protein seasonings that can be added to different foods and/or liquids. The base formulation can Include a vegetable extract. The protein source can include one or more of whey protein, whey concentrate, milk protein, calcium caseinate, soy protein, brown rice protein, soluble fiber, non-soluble fiber, hemp protein and egg protein.

### CROSS-REFERENCE TO RELATED APPLICATION(S)

This application relates to and claims priority from U.S. Patent Application Ser. No. 61/550,824 filed Oct. 24, 2011, the entire disclosure of which is hereby incorporated herein by reference.

### FIELD OF THE DISCLOSURE

The present disclosure relates generally to protein seasoning, and more particularly, to exemplary embodiments of protein seasonings and methods of making the same.

### GROUND INFORMATION

Many people can suffer from protein deficiencies, which can lead to poor health and disease. In advanced cultures, wherein sedentary behavior may be commonplace, weight-related health problems can be significant. Existing food products, which can be derived from animal, fish, vegetable and plant sources, can be insufficient to provide the body with a balanced biological and physiological diet. In general, it is recommended that approximately 10%-35% of your daily calories come from protein. Below are general Recommended Dietary Allowances (“RDA”) for different age groups.

Recommended Dietary Allowance for Protein

| | Grams of protein |
|---|---|
| | needed each day |
| Children ages 1-3 | 13 |
| Children ages 4-8 | 19 |
| Children ages 9-13 | 34 |
| Girls ages 14-18 | 46 |
| Boys ages 14-18 | 52 |
| Women ages 19-70+ | 46 |
| Men ages 19-70+ | 56 |

Further, cancer patients undergoing radiation or chemotherapy can often have difficulty in meeting their daily nutritional requirements of protein due to nausea and a lack of appetite. This may lead to weight loss, muscle loss and/or protein calorie malnutrition. Whey protein can be an excellent protein choice for cancer patients as it is very easy to digest and very gentle to the system. Whey protein may be added to a wide variety of foods and beverages to increase the protein content without affecting the taste.

As with athletes, cancer patients can often have reduced glutathione levels and a weakened immune system. Numerous studies have shown that whey protein, rich in the amino acid cysteine, can provide an extra boost to the immune system by raising glutathione levels. This may help reduce the risk of infection and improve the responsiveness of the immune system. In support of this, at the 2003 Annual Meeting of the American Cancer Society, research was presented showing that women with the highest levels of plasma cysteine had a 56% reduction in the risk of breast cancer compared to individuals with the lowest levels of plasma cysteine.

Further, whey protein has been shown through animal and in vitro studies to inhibit the growth of several types of cancer tumors. Dr. Thomas Badger, head of the Arkansas Children's Nutrition Center in Little Rock, Ark., found that feeding rats whey protein resulted in their developing 50% fewer tumors than rats fed casein. The rats fed whey protein also developed fewer tumors than rats fed soy protein, and the tumors took longer to develop in the rats that were fed whey protein.

A few reasons a doctor may recommend extra protein in your diet can include loss of weight and/or appetite, achieving or maintaining a healthy weight, for supplemental nutrition in addition to meals, surgery or an injury where protein may be needed to support the recovery process, trouble swallowing or difficulty chewing solid food, lack of exercise and/or inactivity,

Generally, athletes, patients and others have consumed protein in solid form (e.g., meat, protein bar, etc.) or liquid form (e.g., protein drinks, shakes, etc.). However, when a person has a lack of an appetite, these generally are very filling and/or not flavorful. Thus, there is a need for a protein supplement that that can provide for an amount of protein that may be necessary for the body, and being flavorful and/or not very filling.

### SUMMARY OF EXEMPLARY EMBODIMENTS OF THE DISCLOSURE

At least some of the above described problems can be addressed by exemplary embodiments of the protein seasoning and method of making the same according to the present disclosure. A base formulation can be combined with a protein formulation, which can be combined with various seasonings/ingredients to form various protein seasonings that can be added to different foods and/or liquids.

In some exemplary embodiments of the present disclosure, a protein seasoning can be provided, comprising a formulation comprising a base and a protein source, wherein the base comprises an extract, and a flavored seasoning in a powdered form. The base and protein source in the formulation can be provided in a powder form. The base can comprise a vegetable extract, and can also comprise a yeast extract. The vegetable extract and yeast extract can comprise approximately 40% to approximately 60% of the base.

The base can further comprise approximately 2.5% to approximately 6% of mirepoix powder, approximately 6% to approximately 15% of yeast extract, approximately 3% to approximately 9% of natural butter flavor, approximately 8% to approximately 18% of corn starch, and/or approximately 1% to approximately 5% of turmeric powder.

The protein source can comprise one or more of whey protein, whey concentrate, milk protein, calcium caseinate, soy protein, brown rice protein, soluble fiber, non-soluble fiber, hemp protein and egg protein. In some exemplary embodiments, the protein source can comprise a combination of whey protein and calcium caseinate. The protein source can comprise approximately 50% whey protein and approximately 50% calcium caseinate. The base can comprise approximately 40% to approximately 60% of the formulation, and the protein source can comprise approximately 40% to approximately 60% of the formulation.

In some exemplary embodiments of the present disclosure, a protein seasoning can be provided, comprising a formulation comprising approximately 50% to approximately 60% of a protein source in a powder form comprising a combination of whey protein and calcium caseinate, wherein the whey protein comprises approximately 20% to approximately 75% of the protein source and the calcium caseinate comprises approximately 20% to approximately 75% of the protein source, and approximately 40% to approximately 50% of an extract comprising a vegetable extract and a yeast extract, and a flavored seasoning.

In some exemplary embodiments of the present disclosure, a method of manufacturing a protein seasoning can be provided, comprising providing a formulation comprising approximately 40% to approximately 60% of a base comprising an extract, and approximately 40% to approximately 60% of a protein source, and mixing or blending a flavored seasoning to the formulation.

The formulation can comprise approximately 55% of the protein source and approximately 45% of the base. The base can comprise approximately 40% to approximately 60% vegetable extract. The protein source can comprise one or more of whey protein, whey concentrate, milk protein, calcium caseinate, soy protein, brown rice protein, soluble fiber, non-soluble fiber, hemp protein and egg protein. The protein source can be a combination of whey protein and calcium caseinate, wherein the protein source comprises approximately 50% whey protein and approximately 50% calcium caseinate.

The present disclosure provides exemplary embodiments of a protein seasoning that can be added to food to provide the grams of protein that may be needed by the body, and that can enhance the flavor of the food itself. Different amounts and flavors of the protein seasoning can be provided to various foods to supplement and provide a person with the amount of protein that may be necessary for the body. Different seasonings and varied amounts of the seasoning can provide an amount of grams of protein per serving as recommended for different people that can be based on different requirements.

### DETAILED DESCRIPTION OF EXEMPLARY EMBODIMENTS OF DISCLOSURE

Exemplary embodiments of the protein seasoning and method of making the same according to the present disclosure are described below.

Initially, in an exemplary embodiment of the present disclosure, several formulations of protein seasoning were produced using separate amounts of various different protein sources. For example, various formulations were made using different amounts and types of whey protein, soy protein and brown rice protein, and the disclosure is not limited to these types of proteins. Various seasonings can be included in the formulations, including but not limited to salt, pepper, garlic powder, onion powder, celery seed, paprika, poultry seasoning and dried parsley. A base of natural extracts were also provided which can include but are not limited to yeast extract, natural powdered butter, flavor & corn starch with turmeric for color.

### Exemplary Base and Protein Source

In exemplary embodiments of the present disclosure, the protein seasoning can include two ingredients, but is not limited to such. One can be the base, and the other can be the protein source.

The base can include, but is not limited to, an extract. For example, a vegetable extract such as a vegetable extract powder, which can be an extract of Chinese cabbage that has been spray dried onto a maltodextrin carrier. The extract can be approximately 40% to approximately 65% of the total base, and can be approximately 52.5% of the total base. In some exemplary embodiments, the extract can include vegetable extract in combination with yeast extract. The total extract in the base can be approximately 60% to approximately 90% vegetable extract and approximately 10% to approximately 40% yeast extract.

The base can also include mirepoix powder, which can be cooked vegetables that have been continuously vacuum dried (CVD) on a maltodextrin carrier with sugar, salt & spices. The mirepoix powder can be approximately 2.5% to approximately 6.0% of the total base, and can be approximately 4.3% of the total base. The base can also include a low sodium yeast extract, which can be approximately 6% to approximately 15% of the total base, and can be approximately 11% of the total base. The base can also include natural butter flavor, which can be natural butter flavor that is encapsulated into a water soluble powder that has been spray dried with whey powder & maltodextrin. The natural butter flavor can be approximately 3% to approximately 9% of the total base, and can be approximately 7% of the total base. The base can also include corn starch, which can be approximately 8% to approximately 18% of the total base, and can be approximately 13% of the total base. The base can also include turmeric powder, which can be approximately 1% to approximately 5% of the total base, and can be approximately 3.5% of the total base. The base is not limited to the ingredients above, and can be different combinations of the above ingredients with various percentages, and the disclosure is not limited to the amounts set out above.

The protein source can be one or more of whey protein, whey concentrate, milk protein, calcium caseinate, soy protein, brown rice protein, soluble fiber, non-soluble fiber, hemp protein and egg protein, but is not limited to these proteins. Other proteins may also be used as the protein source. Different amounts and combinations of the various proteins can be used as the protein source, and the present disclosure is not limited to any particular combination or amount of each protein in the protein source. For example, in some exemplary embodiments, any of these proteins can be used in combinations anywhere from approximately 5% to approximately 95%.

In some exemplary embodiments, the protein source can come from a combination of whey protein and calcium caseinate. The whey protein can be approximately 20% to approximately 75% by weight of the protein source, and the calcium caseinate can be approximately 20% to approximately 75% by weight of the protein source. In some exemplary embodiments, the whey protein can be approximately 50% by weight of the protein source, and the calcium caseinate can be approximately 50% by weight of the protein source.

In some exemplary embodiments, the protein source can come from a combination of whey, soy & brown rice protein. In some exemplary embodiments, the whey protein can be approximately 80% to approximately 95% by weight of the protein source, and can be approximately 93% in some exemplary embodiments. The soy protein can be approximately 5% to approximately 15% by weight of the protein source, and can be approximately 5% in some exemplary embodiments. The brown rice protein can be approximately 2% to approximately 8% by weight of the protein source, and can be approximately 2% in some exemplary embodiments.

### Exemplary Manufacturing Process

Various processes and methods can be used to combine the protein source and the base, and the present disclosure is not limited to any method or procedure. In some exemplary embodiments of the present disclosure, a manufacturing process can be provided where all ingredients of the base can be weighed by the formulas standards based on, e.g., the percentages described above. The base ingredients can be placed into a mechanical mixing device, and mixed and/or blended to produce, e.g., a base formulation. The protein ingredients for the protein source can be weighed by the formulas standards based on, e.g., the percentages described above. The protein ingredients can be placed into a mechanical mixing device, and mixed and/or blended to produce, e.g., a protein formulation.

The blended base and protein formulations can be weighed by the formulas standards and placed together into a mechanical mixing device, and mixed and/or blended. In exemplary embodiments of the present disclosure, the protein formulation can comprise approximately 30% to approximately 60% of the total formulation, and can be approximately 55%, and the base formulation can be approximately 40% to approximately 70% of the total formulation and can be approximately 45%. The total formulation can vary based on the amount of protein formulation and base formulation depending on, e.g., a person's needs, tastes and/or requirements, and are not limited to the above percentages.

The base and protein formulations can vary and are not limited to the ingredients described above. Further, various sizes and types of mixing devices are contemplated by the present disclosure and are not limited to any type of particular device, and can be manually mixed as well. For example, the mixing devices/methods can be, but are not limited to, a standard planetary mixer (floor and/or counter top versions and different sizes, using the Flat Beater, the Wire Whip, and/or the Dough Hook Method) a slant “V” mixer, a ribbon mixer, a paddle mixer, hand & bowl with wire whisk mixing, barrel mixer (manual or machine), dry product & poly bag mixing technique, a counter top mechanical mixer, a food processor (that can mix both commercial size and smaller counter top home size units), a hand held power mixer with bowl, immersion blender and bowl mixing, electric blender mixing (for both commercial and smaller home style units), buffalo chopper mixing, salad and greens spinning device, electric juicer mixing, dry coffee grinding and spice grinding devices, large and small sifter mixing, large and small sieve mixing, fine grate colander mixing and hand mixing.

### Exemplary Seasoning Combinations

In exemplary embodiments, the total formulation including the protein formulation and the base formulation can be combined with various seasonings to produce different tastes and combinations of the protein seasoning of the present disclosure. The amount of flavor can vary depending on the particular flavor or seasoning. For example, in some embodiments the total formulation (i.e., the base and protein source) to flavor ratio can be approximately 10:1, and in some embodiments can range up to 1:2.

For example, in some exemplary embodiments, for an “original blend” flavor, approximately 1 lb. to approximately 2 lbs. of the total formulation can be provided, and can be approximately 1.5 lbs. Approximately 0.15 lbs. to approximately 0.4 lbs. of black pepper can be provided, and approximately 0.25 lbs. of black pepper can be provided. Approximately 0.01 lbs. to approximately 0.06 lbs. of dried parsley can be provided, and approximately 0.03 lbs. of dried parsley can be provided. Approximately 0.01 lbs. to approximately 0.06 lbs. of dried basil can be provided, and approximately 0.03 lbs. of dried basil can be provided. Approximately 0.01 lbs. to approximately 0.06 lbs. of dried dill weed can be provided, and approximately 0.03 lbs. of dried dill weed can be provided.

In some exemplary embodiments, for a “southwestern blend” flavor, approximately 1 lb. to approximately 2 lbs. of the total formulation can be provided, and can be approximately 1.5 lbs. Approximately 0.0625 lbs. to approximately 0.20 lbs. of ground garlic can be provided, and approximately 0.125 lbs. of ground garlic can be provided. Approximately 0.0625 lbs. to approximately 0.20 lbs. of ground cumin can be provided, and approximately 0.125 lbs. of ground cumin can be provided. Approximately 0.0625 lbs. to approximately 0.20 lbs. of ground onion can be provided, and approximately 0.125 lbs. of ground onion can be provided. Approximately 0.0625 lbs. to approximately 0.20 lbs. of chili powder can be provided, and approximately 0.125 lbs. of chili powder can be provided. Approximately 0.04 lbs. to approximately 0.125 lbs. of black pepper can be provided, and approximately 0.09 lbs. of black pepper can be provided. Approximately 0.02 lbs. to approximately 0.09 lbs. of cayenne pepper can be provided, and approximately 0.06 lbs. of cayenne pepper can be provided. Approximately 0.03 lbs. to approximately 0.10 lbs. of oregano can be provided, and approximately 0.06 lbs. of oregano can be provided. Approximately 0.03 lbs. to approximately 0.125 lbs. of chipotle pepper can be provided, and approximately 0.09 lbs. of chipotle pepper can be provided.

In some exemplary embodiments, for a “Mediterranean blend” flavor, approximately 1 lb. to approximately 2 lbs. of the total formulation can be provided, and can be approximately 1.5 lbs. Approximately 0.06 lbs. to approximately 0.25 lbs. of basil can be provided, and approximately 0.1875 lbs. of basil can be provided. Approximately 0.0625 lbs. to approximately 0.20 lbs. of oregano can be provided, and approximately 0.125 lbs. of oregano can be provided. Approximately 0.01 lbs. to approximately 0.06 lbs. of ground garlic can be provided, and approximately 0.03 lbs. of ground garlic can be provided. Approximately 0.01 lbs. to approximately 0.06 lbs. of ground onion can be provided, and approximately 0.03 lbs. of ground onion can be provided. Approximately 0.03 lbs. to approximately 0.10 lbs. of parsley can be provided, and approximately 0.06 lbs. of parsley can be provided. Approximately 0.03 lbs. to approximately 0.10 lbs. of black pepper can be provided, and approximately 0.06 lbs. of black pepper can be provided. Approximately 0.03 lbs. to approximately 0.10 lbs. of marjoram can be provided, and approximately 0.06 lbs. of marjoram can be provided. Approximately 0.03 lbs. to approximately 0.10 lbs. of thyme can be provided, and approximately 0.06 lbs. of thyme can be provided. Approximately 0.0625 lbs. to approximately 0.20 lbs. of savory can be provided, and approximately 0.125 lbs. of savory can be provided. Approximately 0.0625 lbs. to approximately 0.20 lbs. of ground sage can be provided, and approximately 0.125 lbs. of ground sage can be provided. Approximately 0.03 lbs. to approximately 0.10 lbs. of mint leaves can be provided, and approximately 0.06 lbs. of mint leaves can be provided. Approximately 0.01 lbs. to approximately 0.06 lbs. of tarragon can be provided, and approximately 0.03 lbs. of tarragon can be provided.

In some exemplary embodiments, for a “bayou blend” flavor, approximately 1 lb. to approximately 2 lbs. of the total formulation can be provided, and can be approximately 1.5 lbs. Approximately 0.06 lbs. to approximately 0.25 lbs. of ground onion can be provided, and approximately 0.1875 lbs. of ground onion can be provided. Approximately 0.06 lbs. to approximately 0.25 lbs. of ground garlic can be provided, and approximately 0.1875 lbs. of ground garlic can be provided. Approximately 0.03 lbs. to approximately 0.10 lbs. of cayenne pepper can be provided, and approximately 0.06 lbs. of cayenne pepper can be provided. Approximately 0.06 lbs. to approximately 0.25 lbs. of ground thyme can be provided, and approximately 0.1875 lbs. of thyme can be provided. Approximately 0.03 lbs. to approximately 0.125 lbs. of oregano can be provided, and approximately 0.09 lbs. of oregano can be provided. Approximately 0.03 lbs. to approximately 0.10 lbs. of basil can be provided, and approximately 0.06 lbs. of basil can be provided. Approximately 0.0625 lbs. to approximately 0.20 lbs. of ground coriander can be provided, and approximately 0.125 lbs. of ground coriander can be provided. Approximately 0.125 lbs. to approximately 0.375 lbs. of paprika can be provided, and approximately 0.25 lbs. of paprika can be provided. Approximately 0.0625 lbs. to approximately 0.20 lbs. of black pepper can be provided, and approximately 0.125 lbs. of black pepper can be provided. Approximately 0.01 lbs. to approximately 0.06 lbs. of crushed red pepper can be provided, and approximately 0.03 lbs. of crushed red pepper can be provided.

In some exemplary embodiments, for a “far east blend” flavor, approximately 1 lb. to approximately 2 lbs. of the total formulation can be provided, and can be approximately 1.5 lbs. Approximately 0.06 lbs. to approximately 0.25 lbs. of curry pow can be provided, and approximately 0.1875 lbs. of curry pow can be provided. Approximately 0.0625 lbs. to approximately 0.25 lbs. of ginger can be provided, and approximately 0.15 lbs. of ginger can be provided. Approximately 0.375 lbs. to approximately 0.8125 lbs. of sesame seeds can be provided, and approximately 0.625 lbs. of sesame seeds can be provided. Approximately 0.15 lbs. to approximately 0.50 lbs. of ground garlic can be provided, and approximately 0.35 lbs. of ground garlic can be provided. Approximately 0.0625 lbs. to approximately 0.20 lbs. of ground onion can be provided, and approximately 0.125 lbs. of ground onion can be provided. Approximately 0.03 lbs. to approximately 0.125 lbs. of ground nori can be provided, and approximately 0.09 lbs. of ground nori can be provided. Approximately 0.06 lbs. to approximately 0.25 lbs. of soy sauce pow can be provided, and approximately 0.1875 lbs. of soy sauce pow can be provided. Approximately 0.03 lbs. to approximately 0.10 lbs. of 5 spice powder can be provided, and approximately 0.06 lbs. of 5 spice powder can be provided.

Various other spices and flavors can be used as the seasoning and the present disclosure is not limited to any particular flavor or seasoning. For example, many different ingredients can be used in various amounts to suit taste, such as but not limited to dried red chilies, coriander seeds, cumin seeds, fenugreek seeds, black mustard seeds, ground turmeric, ground ginger, channa dhal, mung dhal, urad dhal, black peppercorns, fennel seeds, green cardamoms, cloves, nigella seeds, ground asafetida, cilantro (ground and dried or whole), cayenne pepper, mint leaves, blanchan, shallots, white cardamoms and allspice berries.

### Exemplary Preparation

The protein seasoning can be used in a number of ways. For example, the seasoning can be applied to food such as meat or vegetables before being cooked. It can be used to coat food before it is cooked or added to the preparation (e.g., a sauce or a soup) while it is simmering. It can also be applied topically. The seasoning may even be added to a salad or other dish and not heated. There is no restriction on how the seasoning can be used in various foods and meals.

Various other blends, combinations and flavors are contemplated by the present disclosure and are not limited to the above. One skilled in the art would understand that various flavors and combinations can be produced by using the methods and protein blends described above. The exemplary embodiments of the present disclosure can provide for various protein formulations combined with various base formulations, and combined with various ingredients for different flavors. Various mixing and manufacturing processes are also contemplated by the present disclosure, and the mixes/blends described above can be performed with a blender as well as industrial size mixing/blending devices, and all types of mixing/blending devices including various sizes are contemplated by the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous combinations, arrangements, manufacture and methods which, although not explicitly shown or described herein, embody the principles of the disclosure and are thus within the spirit and scope of the disclosure. The disclosures of all documents and publications cited herein are hereby incorporated herein by reference in their entireties.

What is claimed is:

1. A protein seasoning, comprising:
a formulation comprising a base and a protein source, wherein the base comprises an extract; and
a flavored seasoning in a powdered form.

2. The protein seasoning according to claim 1, wherein the base and protein source in the formulation is provided in a powder form.

3. The protein seasoning according to claim 1, wherein the base comprises a vegetable extract.

4. The protein seasoning according to claim 3, wherein the base further comprises a yeast extract.

5. The protein seasoning according to claim 4, wherein the vegetable extract and yeast extract comprises approximately 40% to approximately 60% of the base.

6. The protein seasoning according to claim 4, wherein the base further comprises approximately 2.5% to approximately 6% of mirepoix powder.

7. The protein seasoning according to claim 4, wherein the base further comprises approximately 6% to approximately 15% of yeast extract.

8. The protein seasoning according to claim 4, wherein the base further comprises approximately 3% to approximately 9% of natural butter flavor.

9. The protein seasoning according to claim 4, wherein the base further comprises approximately 8% to approximately 18% of corn starch.

10. The protein seasoning according to claim 4, wherein the base further comprises approximately 1% to approximately 5% of turmeric powder.

11. The protein seasoning according to claim 1, wherein the protein source comprises one or more of whey protein, whey concentrate, milk protein, calcium caseinate, soy protein, brown rice protein, soluble fiber, non-soluble fiber, hemp protein and egg protein.

12. The protein seasoning according to claim 1, wherein the protein source comprises a combination of whey protein and calcium caseinate.

13. The protein seasoning according to claim 12, wherein the protein source comprises approximately 50% whey protein and approximately 50% calcium caseinate.

14. The protein seasoning according to claim 1, wherein the base comprises approximately 40% to approximately 60% of the formulation, and the protein source comprises approximately 40% to approximately 60% of the formulation.

15. A protein seasoning, comprising:
a formulation comprising:
approximately 50% to approximately 60% of a protein source in a powder form comprising a combination of whey protein and calcium caseinate, wherein the whey protein comprises approximately 20% to approximately 75% of the protein source and the calcium caseinate comprises approximately 20% to approximately 75% of the protein source; and
approximately 40% to approximately 50% of an extract comprising a vegetable extract and a yeast extract; and
a flavored seasoning.

16. A method of manufacturing a protein seasoning, comprising:
providing a formulation comprising approximately 40% to approximately 60% of a base comprising an extract, and approximately 40% to approximately 60% of a protein source; and
mixing or blending a flavored seasoning to the formulation.

17. The method of manufacturing a protein seasoning according to claim 16, wherein the formulation comprises approximately 55% of the protein source and approximately 45% of the base.

18. The method of manufacturing a protein seasoning according to claim 16, wherein the base comprises approximately 40% to approximately 60% vegetable extract.

19. The method of manufacturing a protein seasoning according to claim 16, wherein the protein source comprises one or more of whey protein, whey concentrate, milk protein, calcium caseinate, soy protein, brown rice protein, soluble fiber, non-soluble fiber, hemp protein and egg protein.

20. The method of manufacturing a protein seasoning according to claim 16, wherein the protein source comprises a combination of whey protein and calcium caseinate.

21. The method of manufacturing a protein seasoning according to claim 20, wherein the protein source comprises approximately 50% whey protein and approximately 50% calcium caseinate.
